(19) United States
(12) Patent Application Publication
(10) Pub. No.: US 2015/0052613 A1
(43) Pub. Date: Feb. 19, 2015

(54) DATABASE ANTIVIRUS SYSTEM AND METHOD

(71) Applicant: Green SQL Ltd, Tel Aviv-Yafo (IL)

(72) Inventor: David Maman, Tel Aviv-Yafo (IL)

(73) Assignee: GREEN SQL LTD, Tel Aviv-Yafo (IL)

(21) Appl. No.: 14/386,825

(22) PCT Filed: Mar. 19, 2013
(86) PCT No.: PCT/IL2013/050260

§ 371 Date: Sep. 22, 2014

Related U.S. Application Data
(60) Provisional application No. 61/613,496, filed on Mar. 21, 2012.

(51) Int. Cl. G06F 21/56; G06F 17/30

(52) U.S. Cl. CPC G06F 21/561; G06F 17/30424
USPC 726/24

(57) ABSTRACT

A system and method for analyzing a file for a virus for databases through an antiviral apparatus.

### FIELD OF THE INVENTION

The present invention is of a system and method for a database antivirus system and method, and in particular, of such a system and method for providing antivirus functions through an entity that is separate from the database and optionally for analyzing files before they are stored on the database.

### BACKGROUND OF THE INVENTION

Relational databases, and their corresponding management systems, are very popular for storage and access of data. Relational databases are organized into tables which consist of rows and columns of data. The rows are formally called tuples. A database will typically have many tables and each table will typically have multiple tuples and multiple columns. The tables are typically stored on direct access storage devices (DASD) such as magnetic or optical disk drives for semi-permanent storage.

Typically, such databases are accessible through queries in SQL, Structured Query Language, which is a standard language for interactions with such relational databases. An SQL query is received by the management software for the relational database and is then used to look up information in the database tables.

Databases may be corrupted and/or accessed by unauthorized parties, due to computer “viruses”; as used herein, the term “virus” refers to any unauthorized code, which may also optionally include malware of any type (including Trojan Horses) and any type of unauthorized script.

Currently, various databases incorporate defenses against such viruses as part of their structure. One example of such a defense is described with regard to US

Patent Application No. US20070168678. However, such integrated antivirus defenses have many disadvantages, including the potential to reduce database responsiveness and also the additional computational load placed on the hardware operating the database.

### SUMMARY OF THE INVENTION

The background art does not teach or suggest a system or method for providing remote antiviral functionality for a database. The background art does not teach or suggest such a system or method which supports detection and/or blocking of transmission of such viruses to or from the database.

The present invention overcomes the deficiencies of the background art by providing a system and method, in at least some embodiments, for providing a remote antivirus defense for a database. By “remote” it is meant that the hardware operating the antivirus defense is optionally separate from the hardware operating the database, but at least that the antivirus defense is operated separately from the database (even if operated by the same hardware as the database). By “antivirus” it is meant a defense against any unauthorized code, which may also optionally include malware of any type (including Trojan Horses) and any type of unauthorized script. The defense may optionally relate to prevention of viral transmission to and/or from the database, or to detection of such viral transmission. In any case, preferably an alert is issued once a virus is detected.

Unless otherwise defined, all technical and scientific terms used herein have the same meaning as commonly understood by one of ordinary skill in the art to which this invention belongs. The materials, methods, and examples provided herein are illustrative only and not intended to be limiting.

Implementation of the method and system of the present invention involves performing or completing certain selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

Although the present invention is described with regard to a “computer” on a “computer network”, it should be noted that optionally any device featuring a data processor and the ability to execute one or more instructions may be described as a computer, including but not limited to any type of personal computer (PC), a server, a cellular telephone, an IP telephone, a smart phone, a PDA (personal digital assistant), or a pager. Any two or more of such devices in communication with each other may optionally comprise a “computer network”.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 shows an exemplary, illustrative non-limiting system for a remote antiviral defense, in which the hardware operating the defense is separate from the hardware operating the database, according to some embodiments of the present invention;

FIG. 2 shows an alternative, illustrative exemplary system according to at least some embodiments of the present invention, in which the antiviral defense hardware is incorporated within the database hardware but which is operated separately from the database; and

FIGS. 3A and 3B are flow diagrams of exemplary, illustrative method for operation of a remote antiviral defense according to at least some embodiments of the present invention.

### DESCRIPTION OF THE PREFERRED EMBODIMENTS

The present invention provides a system and method, in at least some embodiments, for a remote antiviral defense that is remote from a database.

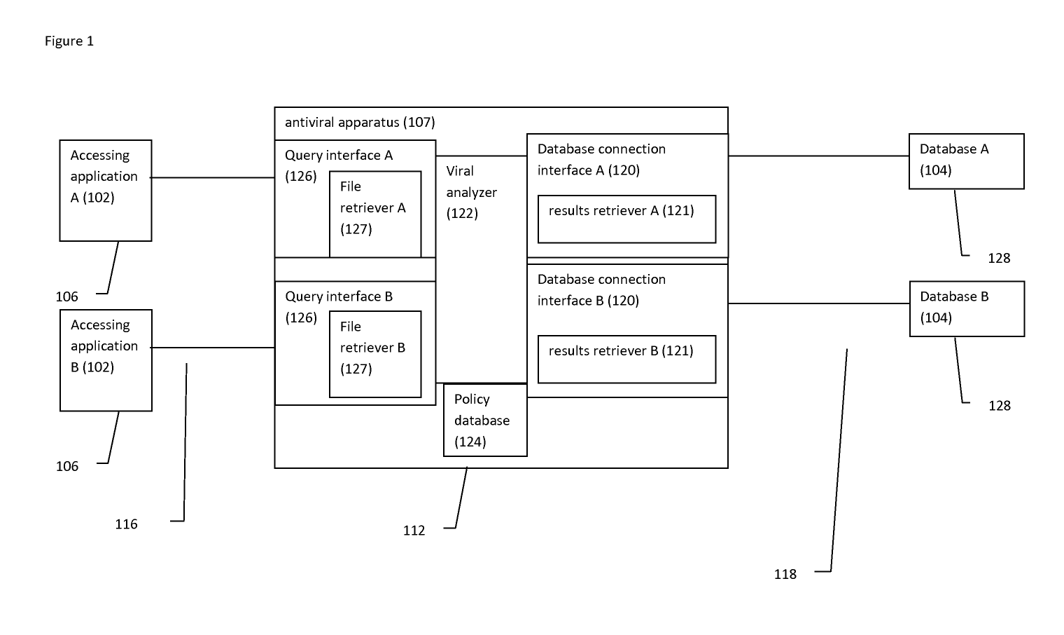

Referring now to the drawings, FIG. 1 shows an exemplary, illustrative non-limiting system for a remote antiviral defense that is operated by separate hardware from the database. As shown in FIG. 1, a system 100 features a plurality of accessing applications 102 for providing a software application interface to access one or more of a plurality of databases 104. Two accessing applications 102, A and B, are shown; as are two databases 104, A and B, for the purpose of illustration only and without any intention of being limiting.

Accessing application 102 may optionally be any type of software, or many optionally form a part of any type of software, for example and without limitation, a user interface, a back-up system, web applications, data accessing solutions, data warehouse solutions, CRM (customer relationship management) software and ERP (enterprise resource planning) software. Accessing application 102 is a software application (or applications) that is operated by some type of computational hardware, shown as a computer 106. However, optionally computer 106 is in fact a plurality of separate computational devices or computers, any type of distributed computing platform and the like; nonetheless, a single computer is shown for the sake of clarity only and without any intention of being limiting.

Similarly, database 104 is a database software application (or applications) that is operated by some type of computational hardware, shown as a computer 128. Again, optionally computer 128 is in fact a plurality of separate computational devices or computers, any type of distributed computing platform and the like; nonetheless, a single computer is shown for the sake of clarity only and without any intention of being limiting.

System 100 comprises an antiviral apparatus 107 which preferably comprises a viral analyzer 122, for analyzing incoming queries for viruses and for analyzing results retrieved from database 104 for viruses. As described in greater detail below, any action taken by viral analyzer 122 upon detecting a virus in an incoming query or in retrieved results is preferably determined by a policy stored in a policy database 124.

Viral analyzer 122 preferably is in communication with accessing applications 102 A and B through a query interface A 126 or a query interface B 126, respectively. Query interface 126 may optionally be adapted for each accessing application 102; alternatively a single query interface 126 may optionally be provided (not shown). Query interface 126 is preferably adapted to handle any changes, translations or other activities required for a query to be reviewed by viral analyzer 122, in case of an incoming file.

It should be noted that the term “file” as used herein encompasses any suitable unit of data, including but not limited to a blob (binary large object).

Query interface 126 preferably also comprises a file retriever 127, which again may optionally be adapted for each of accessing applications 102 A and B as file retriever A and B 127, respectively; alternatively, a single file retriever 127 may be implemented (not shown). File retriever 127 preferably receives an incoming file and then passes it to viral analyzer 122.

Viral analyzer 122 is preferably adapted to analyze an incoming file to determine whether the file is compressed (and if so, more preferably to decompress it), and to also optionally and more preferably decrypt an encrypted file. If the file is encrypted, preferably viral analyzer 122 has access to the necessary keys for decryption. The antivirus solution policy can determine that if a file is encrypted, and there is no key, the file should be blocked from being written to the database or retrieved from the database.

Once the file has been decrypted and/or decompressed, viral analyzer 122 also preferably types the file to determine its “type” or format. The policy may optionally determine that only certain types or formats of files may be written to the database. For example, optionally images may not be written or may be written to the database, according to the policy. As another example, executable binary files may be blocked from being written to the database according to the policy. Optionally for any blocked file type, viral analyzer 122 does not pass the file forward to continue with the analysis process.

Viral analyzer 122 then preferably analyzes the file to determine whether a virus is present, except as described above (for example, if the file is determined to belong to a blocked type, it may not be further analyzed). Optionally and preferably, if viral analyzer 122 is not able to decompress and/or to decrypt the file, viral analyzer 122 more preferably takes an action as determined according to a policy in policy database 124. For example, optionally, viral analyzer 122 may block further transmission of the file if the policy requires prevention of transmission. Alternatively, viral analyzer 122 may only determine that such a virus has been detected but may not block further transmission. In this case, viral analyzer 122 preferably passes the file to database 104 as described in greater detail below. In either case, viral analyzer 122 preferably sends an alert to one or more designated authorities (not shown), for example by email, text message or other messaging. Also in either case, viral analyzer 122 may optionally return an error message to accessing application 102, for example indicating that a virus was detected and/or indicating an error for example. Each of these actions is preferably determined according to the previously described policy, which may optionally be determined for example by a system administrator.

Assuming that the file was decrypted and/or decompressed, or otherwise made available for analysis, viral analyzer 122 preferably analyzes the file to detect a virus of any type. Viral analyzer 122 may optionally comprise any “off the shelf” viral analysis engine and may also optionally comprise a plurality of such engines as is known in the art. Viral analyzer 122 may also optionally comprise a combination of firmware and/or software and/or hardware as is known in the art. Viral analyzer 122 may optionally comprise a remote viral analysis engine, including for example a cloud service antiviral function (not shown) or a plurality of such engines and/or functions (also not shown).

If a virus is detected, viral analyzer 122 then preferably takes an action as determined according to a policy stored in policy database 124 as previously described.

If a virus is not detected, or if the policy determines that the file is to be passed to database 104, then the file is preferably passed to database connection interface 120. Database connection interface 120 then writes the file to database 104.

Database connection 120 preferably comprises a database connection interface A and B 120 as shown. Each database connection interface 120 is optionally specific for a particular type of database software 104, for example; optionally only a single such database connection interface 120 may be implemented (not shown). Database connection interface 120 is preferably able to communicate with each database 104, to send queries and to receive results.

The previously described actions apply for situations in which a file is sent by accessing application 102 for writing to database 104. If accessing application 102 sends a read request to query interface 126, then the read request is preferably not analyzed by viral analyzer 122. Instead query interface 126 preferably performs any necessary functions for the read request to be transmitted to database 104. The request is then passed to database 104 through database connection interface 120, optionally bypassing viral analyzer 122 (not shown).

Database connection interface 120 then passes the read request to database 104 and receives the results thereof. The results preferably pass to a results retriever 121, which may optionally comprise results retrievers 121 A and B, corresponding to databases A and B 104, respectively. Alternatively, only one results retriever 121 may optionally be implemented (not shown).

Results retriever 121 is preferably adapted to receive the results from databases A or B 104, and to pass results comprising a file to viral analyzer 122. Viral analyzer 122 then preferably operates as previously described. In any case, viral analyzer 122 more preferably takes an action as determined according to a policy in policy database 124. For example, optionally, viral analyzer 122 may block further transmission of the file if the policy requires prevention of transmission. Alternatively, viral analyzer 122 may only determine that such a virus has been detected but may not block further transmission. In this case, viral analyzer 122 preferably passes the file to accessing application 102 as described in greater detail below. In either case, viral analyzer 122 preferably sends an alert to one or more designated authorities (not shown), for example by email, text message or other messaging. Also in either case, viral analyzer 122 may optionally return an error message to accessing application 102, for example indicating that a virus was detected and/or indicating an error for example. Each of these actions is preferably determined according to the previously described policy, which may optionally be determined for example by a system administrator.

If a virus is not detected, or if the policy determines that the file is to be passed to accessing application 102, then the file is preferably passed to query interface 126. Query interface 126 then transfers the file to accessing application 102.

As shown in FIG. 1, antiviral apparatus 107, accessing application 102 and database 104 preferably communicate through some type of computer network, although optionally different networks may communicate between accessing application 102 and antiviral apparatus 107 (as shown, a computer network 116), and between antiviral apparatus 107 and database 104 (as shown, a computer network 118). For example, computer network 116 may optionally be the Internet, while computer network 118 may optionally comprise a local area network, although of course both networks 116 and 118 could be identical and/or could be implemented according to any type of computer network.

In this embodiment of the system 100 according to the present invention, antiviral apparatus 107 preferably is addressable through both computer networks 116 and 118; for example, antiviral apparatus 107 could optionally feature an IP address for being addressable through either computer network 116 and/or 118.

Database 104 may optionally be implemented according to any type of database system or protocol; however, according to preferred embodiments of the present invention, database 104 is implemented as a relational database with a relational database management system. Non-limiting examples of different types of databases include SQL based databases, including but not limited to MySQL, Microsoft SQL, Oracle SQL, PostgreSQL, and so forth.

Optionally and preferably, system 100 may comprise a plurality of different databases 104 operating according to different database protocols and/or query languages and/or even having different structures. However, system 100 is also useful for a single database 104 (or multiple databases 104 of a single type, having a common database protocol, structure and/or query language), in that system 100 permits complete flexibility with regard to accessing application 102 and database 104; these two components do not need to be able to communicate with each other directly. As previously described, this lack of a requirement for direct communication may optionally be useful, for example, for legacy systems, or indeed for any system in which it is desirable to remove this requirement. Furthermore, this lack of a requirement may optionally be useful for organizations which have knowledge and skills with regard to particular types of database protocols, languages and/or software, but which may lack knowledge with regard to one or more other types.

These embodiments with regard to different database types and non-limiting examples of advantages may also optionally be applied to any of the embodiments of the system according to the present invention as described herein.

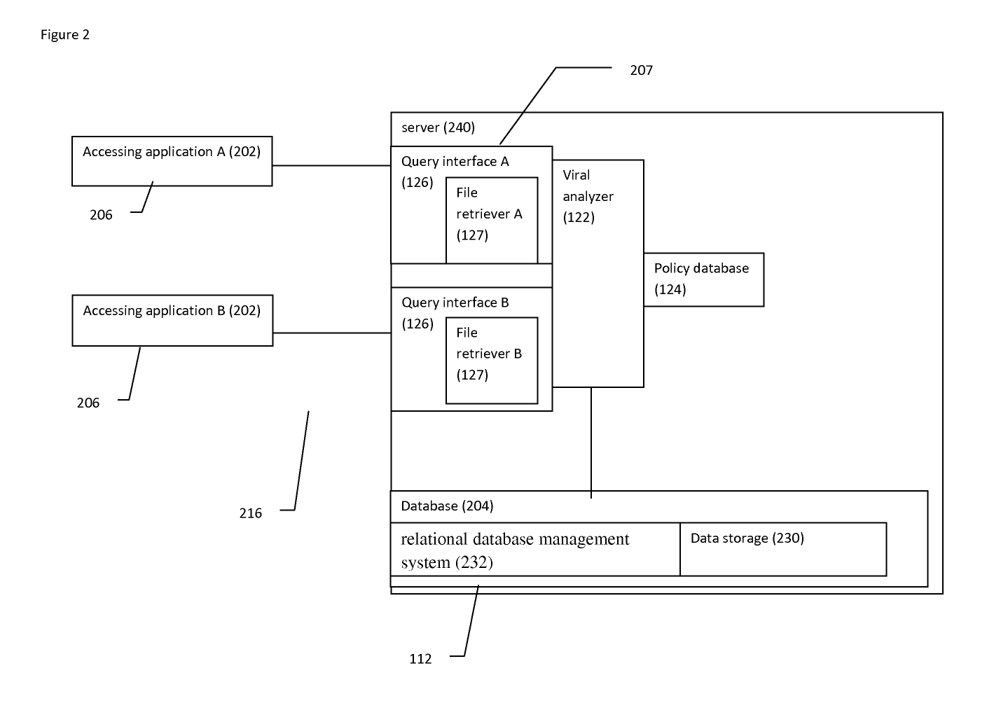

FIG. 2 shows an alternative, illustrative exemplary system according to at least some embodiments of the present invention, in which the antiviral apparatus is co-located with the database, such that the antiviral apparatus is operated by the same hardware as the database; the hardware may optionally be a single hardware entity or a plurality of such entities. For this exemplary system, the database is shown as a relational database with a relational database management system for the purpose of illustration only and without any intention of being limiting.

Components with the same or similar function are shown with the same reference number plus 100 as for FIG. 1.

The operation of antiviral apparatus 207 is similar for FIG. 2, except that for those embodiments, antiviral apparatus 207 is operated by the same hardware that operates the database, as described in greater detail below.

As shown with regard to FIG. 2, system 200 again features a plurality of accessing applications 202, of which two are shown, accessing applications 202 A and B, but in this case these accessing applications 202 are addressing a single database 204. Database 204 is preferably implemented as a relational database, with a data storage 230 having a relational structure and a relational database management system 232. Accessing application 202 addresses database 204 according to a particular port; however, as database 204 is operated by a server 240 as shown, accessing application 202 sends the query to the network address of server 240.

Unlike for the system of FIG. 1, antiviral apparatus 207 is preferably running over the same hardware as database 204, optionally by single server 240 as shown or alternatively through distributed computing, rather than being implemented as a separate apparatus.

As noted above, accessing application 202 sends the query for database 204 to the network address of server 240. The query is sent to a particular port; this port may optionally be the regular or “normal” port for database 204. Otherwise, accessing application 202 may optionally send the query to a different port for antiviral apparatus 207, so that antiviral apparatus 207 communicates with database 204 through a different port.

Preferably, antiviral apparatus 207 receives queries through a particular port for each database type. By “database type” it is meant a particular combination of database structure, protocol and query language; databases of the same database type can communicate freely without translation. For example, one database type could optionally be a relational database operated by MySQL, while another database type could optionally be a relational database operated by MS (Microsoft) SQL. Queries for each such type are preferably received through a different port, which accessing application 202 is more preferably configured to access. Optionally there could be a generic port for any non pre-configured database types.

For either of the systems of FIG. 1 or 2, optionally the antiviral apparatus 107 or 207 may additionally or alternatively scan database 104 or 204 to detect the presence of a virus. For this implementation, optionally viral analyzer 122 communicates with database 104 or 204 to retrieve files and then performs the previously described analysis. In this case of system 100 of FIG. 1, optionally and preferably antiviral apparatus 104 communicates with database 104 through database connection interface 120 to retrieve the file; viral analyzer 122 then performs the analysis as previously described.

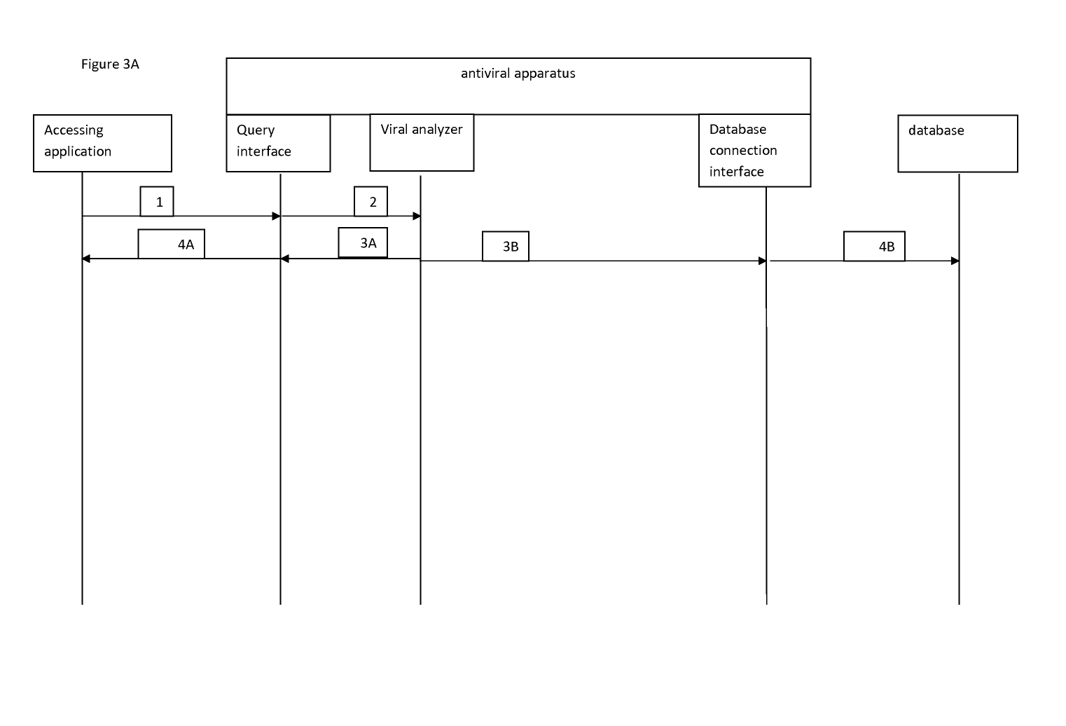

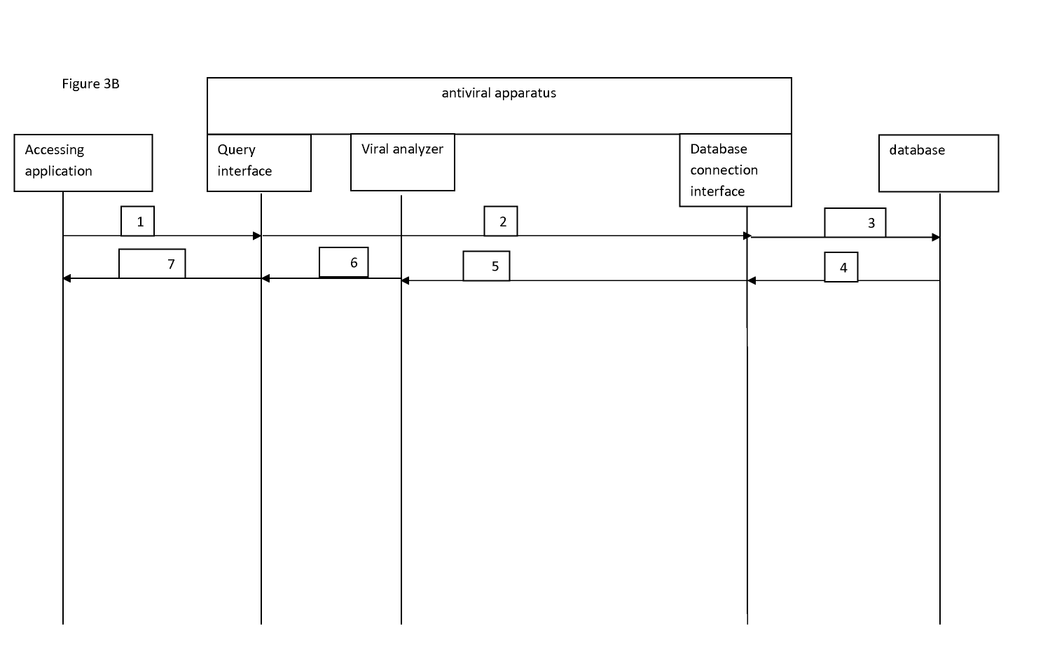

FIGS. 3A and 3B are flowcharts of exemplary, illustrative methods for operation of an antiviral apparatus according to at least some embodiments of the present invention, with interactions between the accessing application, antiviral apparatus, and the database. FIG. 3A relates to the method for handling a write query from an accessing application while FIG. 3B relates to the method for handling a read query from an accessing application, according to various embodiments of the present invention. Arrows show the direction of interactions.

It is assumed, before the method starts, that a policy (or policies) has been set to determine the action(s) to be taken if a virus is detected.

As shown, in stage 1, an accessing application generates a query, which may optionally be a read query or a write query; for FIG. 3A as shown, the query is a write query. The accessing application then sends the write query, including a file, to the antiviral apparatus and specifically to the query interface as previously described.

In stage 2, the query interface then passes the file to the viral analyzer. The viral analyzer then optionally and preferably decompresses and/or decrypts the file as previously described. If the file could not be decompressed and/or decrypted, optionally an error message is returned instead and the process stops.

The viral analyzer analyzes the file if it is accessible for analysis, for example because it has been decompressed and/or decrypted. If a virus is detected, or if the file was not accessible for analysis because it was not decompressed and/or decrypted, then optionally and preferably, a notification message is sent to an authority or authorities (not shown). Optionally, an error message or other message may be sent to the query interface in stage 3A, which is then transmitted to the accessing application in stage 4A as shown. The error message may optionally indicate that the file will not be transmitted to the database, due to the presence of the virus. The contents of the message and also whether the message is sent are both preferably determined according to a policy as previously described.

If a virus is not detected, or if the policy indicates that the file is to be passed on to the database even if a virus is detected, then in stage 3B, the file is passed to the database connection interface. The file is then passed to the database in stage 4B as previously described.

Turning now to FIG. 3B, in which a query is requesting a file to be sent from the database, as shown, in stage 1, an accessing application generates a query, which in this case is a read query. The query is sent to the query interface, which then preferably sends it directly to the database connection interface, optionally and preferably bypassing the viral analyzer in stage 2. The data connection interface then sends the query to the database in stage 3.

The database returns a file to the database connection interface in stage 4. In stage 5, the file is then passed to the viral analyzer, which preferably decompresses and/or decrypts the file as previously described. Optionally if the viral analyzer was not able to decrypt and/or decompress the file, the process stops; optionally an error message is returned instead.

The viral analyzer analyzes the file if it is accessible for analysis, for example because it has been decompressed and/or decrypted. If a virus is detected, or if the file was not accessible for analysis because it was not decompressed and/or decrypted, then optionally and preferably, a notification message is sent to an authority or authorities (not shown). Optionally, an error message or other message may be sent to the query interface in stage 6, which is then transmitted to the accessing application in stage 7 as shown. The error message may optionally indicate that the file will not be transmitted to the accessing application, due to the presence of the virus. The contents of the message and also whether the message is sent are both preferably determined according to a policy as previously described.

If a virus is not detected, or if the policy indicates that the file is to be passed on to the accessing application even if a virus is detected, then in stage 6, the file is passed to the query interface. The file is then passed to the accessing application in stage 7 as previously described.

While the invention has been described with respect to a limited number of embodiments, it will be appreciated that many variations, modifications and other applications of the invention may be made.

1. A remote antivirus defense system for a database, wherein the database is operated by database hardware, the system comprising an antivirus defense apparatus, wherein said apparatus is operated by hardware other than said database hardware, said antivirus defense apparatus screening write queries to said database and read query results from said database, and said antivirus defense apparatus issuing an alert if a virus is detected.

2. (canceled)

3. The apparatus of claim 1, wherein said antivirus defense apparatus blocks a write query to said database if said write query contains a virus.

4. The apparatus of claim 1, wherein said antivirus defense apparatus blocks results of a read query from said database if said results contain a virus.

5. The apparatus of claim 1, wherein said virus comprises any type of unauthorized code.

6. The apparatus of claim 1, wherein the query is related to reading or writing a file.

7. The apparatus of claim 6, wherein said file comprises a blob.

8. A remote antivirus defense system for a database, wherein the database is operated by database hardware, the system comprising an antivirus defense apparatus, wherein said apparatus is operated by said database hardware as a separate process or processes, said antivirus defense apparatus screening write queries to said database and read query results from said database, and said antivirus defense apparatus issuing an alert if a virus is detected.

9. The apparatus of claim 8, wherein said antivirus defense apparatus blocks a write query to said database if said write query contains a virus.

10. The apparatus of claim 8, wherein said antivirus defense apparatus blocks results of a read query from said database if said results contain a virus.

11. The apparatus of claim 8, wherein said virus comprises any type of unauthorized code.

12. The apparatus of claim 8, wherein the query is related to reading or writing a file.

13. The apparatus of claim 12, wherein said file comprises a blob.
